(19) United States
(12) Patent Application Publication
(10) Pub. No.: US 2012/0117492 A1
(43) Pub. Date: May 10, 2012

(54) METHOD, SYSTEM AND APPARATUS FOR PROCESSING CONTEXT DATA AT A COMMUNICATION DEVICE

(76) Inventors: Ankur Aggarwal, Redwood City, CA (US); Cipson Jose Chiriyakandath, Belmont, CA (US); Suzanne Abellera, Palo Alto, CA (US); Paxton Ronald Cooper, Mountain View, CA (US); Carol C. Wu, Palo Alto, CA (US); Robert Mon, Palo Alto, CA (US)

(21) Appl. No.: 13/196,060

(22) Filed: Aug. 2, 2011

Related U.S. Application Data
(60) Provisional application No. 61/411,027, filed on Nov. 8, 2010.

(51) Int. Cl. G06F 3/048

(52) U.S. Cl. 715/760; 715/810

(57) ABSTRACT

A method and apparatus for processing context data at a communication device is provided. Icon data associated with an application is rendered at a display device, thereby providing rendered icon data at the display device, the icon data and the application stored at a memory. Context data associated with the application is determined by retrieving at least a first portion of the context data from a calendar database, the context data for rendering within the application when the application is executed by a processor and rendered at the display device. A portion of the rendered icon data is updated such that the rendered icon data comprises at least a subset of the context data. When the rendered icon data is actuated, the application is responsively executed at the processor such that the context data is rendered at the display device within a rendering of the application.

### CROSS REFERENCE TO RELATED APPLICATIONS

This application claims priority from U.S. Provisional Patent Application No. 61/411,027, filed on Nov. 8, 2010, said application is incorporated by reference in its entirety.

### FIELD

The specification relates generally to computing devices, and specifically to a method, system and apparatus for processing context data at a communication device.

### BACKGROUND

The evolution of computers is currently quite active in the mobile device environment. It is now well-known to including applications for accessing different types of content data in mobile devices. More recently, there has been a veritable explosion of the number and type of these applications that are configured to the unique form factors and computing environments of mobile devices.

### BRIEF DESCRIPTIONS OF THE DRAWINGS

For a better understanding of the various implementations described herein and to show more clearly how they may be carried into effect, reference will now be made, by way of example only, to the accompanying drawings in which::

FIG. 1 depicts a system including a computing device for processing content data, according to non-limiting implementations.

FIG. 2 depicts a subset of elements of the computing device of FIG. 1, according to non-limiting implementations.

FIG. 3 depicts flow diagram of a method for processing content data, according to non-limiting implementations.

FIG. 4 depicts a rendering of icon data prior to content data being processed, according to non-limiting implementations.

FIG. 5 depicts a system including a computing device for processing content data, according to non-limiting implementations.

FIG. 6 depicts the rendered icon data of FIG. 4 after content data is processed, according to non-limiting implementations.

FIG. 7 a perspective view of the computing device of FIG. 1, wherein icon data is rendered on a display device, according to non-limiting implementations.

FIG. 8 depicts the computing device of FIG. 7 after an application associated with icon data is executed upon actuation of the rendered icon data, according to non-limiting implementations.

FIGS. 9A and 9B respectively depict before and after views of rendered icon data wherein a header portion is dynamically changed after content data is processed, according to non-limiting implementations.

FIGS. 10A and 10B respectively depict before and after views of rendered icon data wherein a shape of the rendered icon data is dynamically changed after content data is processed, according to non-limiting implementations.

FIG. 11 depicts various “live” icons, according to non-limiting implementations.

FIG. 12 depicts a system including a computing device for processing context data, according to non-limiting implementations.

FIG. 13 depicts flow diagram of a method for processing context data, according to non-limiting implementations.

FIG. 14 depicts a rendering of icon data prior to context data being processed, according to non-limiting implementations.

FIG. 15 depicts a system including a computing device for processing context data, according to non-limiting implementations.

FIG. 16 depicts the rendered icon data of FIG. 14 after context data is processed, according to non-limiting implementations.

FIGS. 17 and 18 depict various “live” icons, according to non-limiting implementations.

### DETAILED DESCRIPTION OF THE IMPLEMENTATIONS

An aspect of the specification provides a method for processing context data at a computing device such as a communication device, the communication device including a processor interconnected with a memory, a display device and a communication interface, the method including: rendering icon data associated with an application at the display device, thereby providing rendered icon data at the display device, the icon data and the application stored at the memory; determining context data associated with the application by retrieving at least a first portion of the context data from a calendar database, the context data for rendering within the application when the application is executed by the processor and rendered at the display device; updating a portion of the rendered icon data such that the rendered icon data includes at least a subset of the context data; and when the rendered icon data is actuated, responsively executing the application at the processor such that the context data is rendered at the display device within a rendering of the application.

The application can remain unexecuted until the processor responsively executing the application.

The rendered icon data can include at least one of a header portion and a content portion; the portion of the rendered icon data that is updated can include the content portion. The header portion can be one of: static; or dynamic, such that content of the header changes based on the context data.

A shape of the rendered icon data can be one of: static; or dynamic, such that the shape changes based on at least one of the context data and time.

The context data can includes at least one of HTML (hypertext markup language) data, HTML tags, text data and image data.

Determining the context data can further occur by at least one of: retrieving the at least a first portion of the context data from the calendar database based on a current time; requesting at least a second portion of the context data from a content server based on at least one of the first portion of the context data and the current time; receiving the at least a second portion of the context data from the content server; and an API (application programming interface).

Determining the context data can occur via an API (application programming interface) that interfaces with at least one of the calendar database and a remote content server.

The method can further include storing the context data in a resource file associated with the application, such that the context data can be retrieved from the resource file when the application is executed.

The method can further include requesting content data from a content server based on at least one of at least a portion of the context data and a current time, and wherein updating the portion of the rendered icon data can further include updating the portion of the rendered icon data using at least a subset of the content data.

Another aspect of the specification provides a communication device for processing context data, including: a processor interconnected with a memory, a display device and a communication interface, the processor enabled to: render icon data associated with an application at the display device, thereby providing rendered icon data at the display device, the icon data and the application stored at the memory; determine context data associated with the application by retrieving at least a first portion of the context data from a calendar database, the context data for rendering within the application when the application is executed by the processor and rendered at the display device; update a portion of the rendered icon data such that the rendered icon data includes at least a subset of the context data; and when the rendered icon data is actuated, responsively execute the application such that the context data is rendered at the display device within a rendering of the application.

The application can remain unexecuted until the processor responsively executes the application.

The rendered icon data can include at least one of a header portion and a content portion; the portion of the rendered icon data that is updated can include the content portion.

The header portion can be one of: static; or dynamic, such that content of the header changes based on the context data.

A shape of the rendered icon data can be one of: static; or dynamic, such that the shape changes based on at least one of the context data and time.

The context data can include at least one of HTML (hypertext markup language) data, HTML tags, text data and image data.

To determine the context data, the processor can be further enabled to at least one of retrieve at least a first portion of the context data from the calendar database based on a current time; request at least a second portion of the context data from a content server based on at least one of the first portion of the context data and the current time; receive the at least a second portion of the context data from the content server; and process an API (application programming interface).

To determine the context data, the processor can process an API (application programming interface) that interfaces with at least one of the calendar database and a remote content server.

The processor can be further enabled to store the context data in a resource file associated with the application, such that the context data can be retrieved from the resource file when the application is executed.

The processor can be further enabled to request content data from a content server, and wherein to update the portion of the rendered icon data the processor can be further enabled to update the portion of the rendered icon data using at least a subset of the content data.

Yet a further aspect of the specification provides a computer program product, including a non-transitory computer usable medium having a computer readable program code adapted to be executed to implement a method for processing context data at a communication device, the communication device including a processor interconnected with a memory, a display device and a communication interface, the method including: rendering icon data associated with an application at the display device, thereby providing rendered icon data at the display device, the icon data and the application stored at the memory; determining context data associated with the application by retrieving at least a first portion of the context data from a calendar database, the context data for rendering within the application when the application is executed by the processor and rendered at the display device; updating a portion of the rendered icon data such that the rendered icon data includes at least a subset of the context data; and when the rendered icon data is actuated, responsively executing the application at the processor such that the context data is rendered at the display device within a rendering of the application.

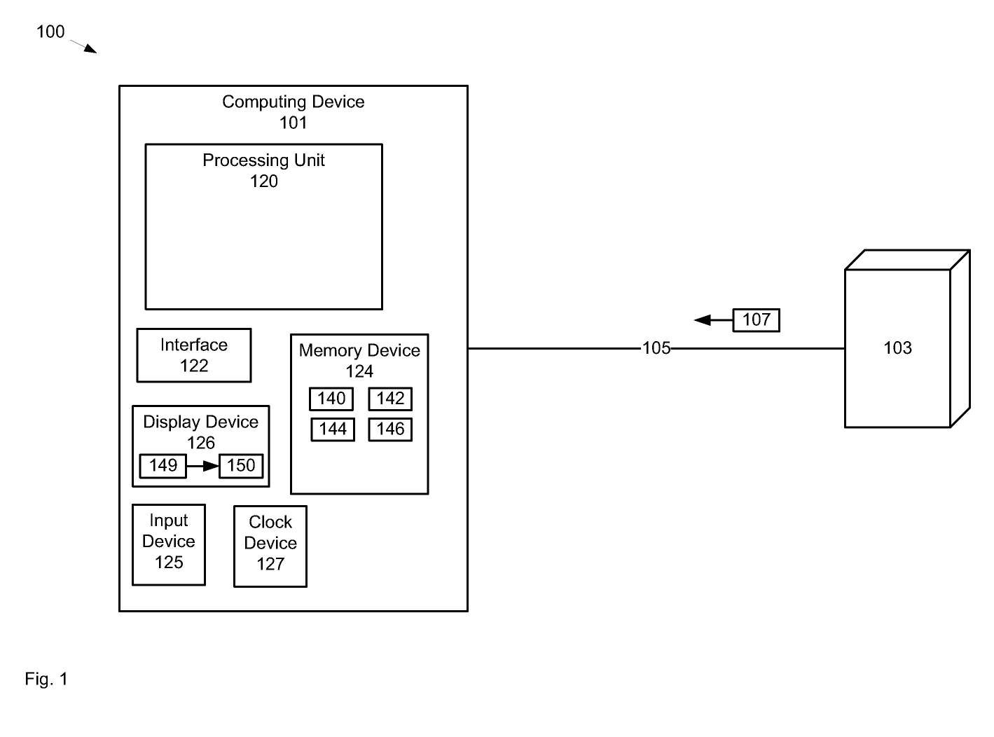

FIG. 1 depicts a system 100 for processing content data at a computing device a computing device 101, according to non-limiting implementations. In some implementations computing device 101 (also be referred to hereafter as device 101) is in communication with a server 103 via a link 105, content data 107 received from server 103 at device 101 via link 105 as will be explained below. Device 101 includes a processing unit 120 interconnected with a communication interface 122, a memory device 124, an input device 125, and a display device 126, for example via a computing bus (not depicted). In some implementations device 101 can also include a clock device 127. Memory device 124 stores icon data 140, an application 142 associated with icon data 140 and further associated with content data 107. Memory device 124 further stores resource file 144, and content data 107 can be stored in resource file 144. Further, memory device 124 (also referred to hereafter as memory 124) stores an application 146 for updating an icon rendered at display device 126 using icon data 140, as will be described below.

In general, device 101 includes any suitable electronic device for processing icon data 140, applications 142, 146, resource file 144 and content data 107, including but not limited to any suitable combination of computing devices, desktop computing devices, laptop computing devices, portable computing device, mobile electronic devices, PDAs (personal digital assistants), cellphones, smartphones and the like. Other suitable electronic devices are within the scope of present implementations.

Server 103 can be based on any well-known server environment including a module that houses one or more central processing units, volatile memory (e.g. random access memory), persistent memory (e.g. hard disk devices) and network interfaces to allow server 103 to communicate over link 105. For example, server 103 can be a ProLiant® Server from Hewlett-Packard Company, 3000 Hanover Street Palo Alto, Calif. 94304-1185 USA having a plurality of central processing units and having several gigabytes of random access memory. However, it is to be emphasized that this particular server is merely a non-limiting example, and a vast array of other types of computing environments for server 103 is contemplated. Furthermore, it is contemplated that server 103 may be implemented as a plurality of interconnected servers, in a so-called server farm, which are mirrored or otherwise configured for load balancing or failover or high availability or any or all of those.

It is yet further contemplated that system 100 can include a plurality of servers (not depicted) similar to server 103, each server in the plurality of servers providing content data for different applications similar to application 142. Indeed, it is contemplated that icon 140, application 142 and resource file 144 can each respectively be one of a plurality of associated icons, applications and sets of resource file for processing and/or rendering content data from respective servers.

Link 105 includes any suitable link between device 101 and server 103, including any suitable combination of wired and/or wireless links, wired and/or wireless devices and/or wired and/or wireless networks, including but not limited to any suitable combination of including but not limited to wired link, USB (universal serial bus) cables, serial cables, wireless links, cell-phone links, wireless data, Bluetooth links, NFC (near field communication) links, WiFi links, WiMax links, packet based links, the Internet, analog networks, the PSTN (public switched telephone network), access points, and the like, and/or a combination. Other suitable communication link and/or devices and/or networks are within the scope of present implementations.

With regard to device 101, processing unit 120 (also referred to hereafter as processor 120) includes any suitable processor, or combination of processors, including but not limited to a microprocessor, a central processing unit (CPU) and the like. Other suitable processing units are within the scope of present implementations. It is appreciated that processing unit 120 is enabled to process icon data 140, applications 142, 146, resource file 144 and content data 107. Further processor 100 can be enabled to execute different programming instructions that can be responsive to the input received via input devices and/or upon receipt of content data 107.

Communication interface 122 includes any suitable communication interface, or combination of communication interfaces. In particular communication interface 122 is enabled to communicate with server 103 via link 105 using any suitable wired and/or wireless protocol. Accordingly, communication interface 122 (which will also be referred to as interface 122 hereafter) is enabled to communicate according to any suitable protocol which is compatible with link 105, including but not limited to wired protocols, USB (universal serial bus) protocols, serial cable protocols, wireless protocols, cell-phone protocols, wireless data protocols, Bluetooth protocols, NFC (near field communication) protocols, packet based protocols, Internet protocols, analog protocols, PSTN (public switched telephone network) protocols, WiFi protocols, WiMax protocols and the like, and/or a combination. Other suitable communication interfaces and/or protocols are within the scope of present implementations.

Input device 125 is generally enabled to receive input data, and can include any suitable combination of input devices, including but not limited to a keyboard, a keypad, a pointing device, a mouse, a track wheel, a trackball, a touchpad, a trackpad, a touch screen and the like. Other suitable input devices are within the scope of present implementations.

Memory device 124 can include any suitable memory device, including but not limited to any suitable one of, or combination of, volatile memory, non-volatile memory, random access memory (RAM), read-only memory (ROM), Erase Electronic Programmable Read Only Memory (EEPROM), Flash Memory hard drive, optical drive, flash memory, magnetic computer storage devices (e.g. hard disks, floppy disks, and magnetic tape), optical discs, removable memory, and the like. Other suitable memory devices are within the scope of present implementations. In particular, memory device 124 is enabled to store icon data 140, applications 142, 146 and resource file 144.

Display device 126 includes circuitry 149 for generating renderings of data, for example a rendering 150 of at least one of icon data 140 and application 146, as will be described below. Display device 126 can include any suitable one of or combination of CRT (cathode ray tube) and/or flat panel displays (e.g. LCD (liquid crystal display), plasma, OLED (organic light emitting diode), capacitive or resistive touchscreens, and the like). Circuitry 149 can include any suitable combination of circuitry for controlling the CRT and/or flat panel displays etc., including but not limited to display buffers, transistors, electron beam controllers, LCD cells, plasmas cells, phosphors etc. In particular, display device 126 and circuitry 149 can be controlled by processing unit 120 to generate rendering 150.

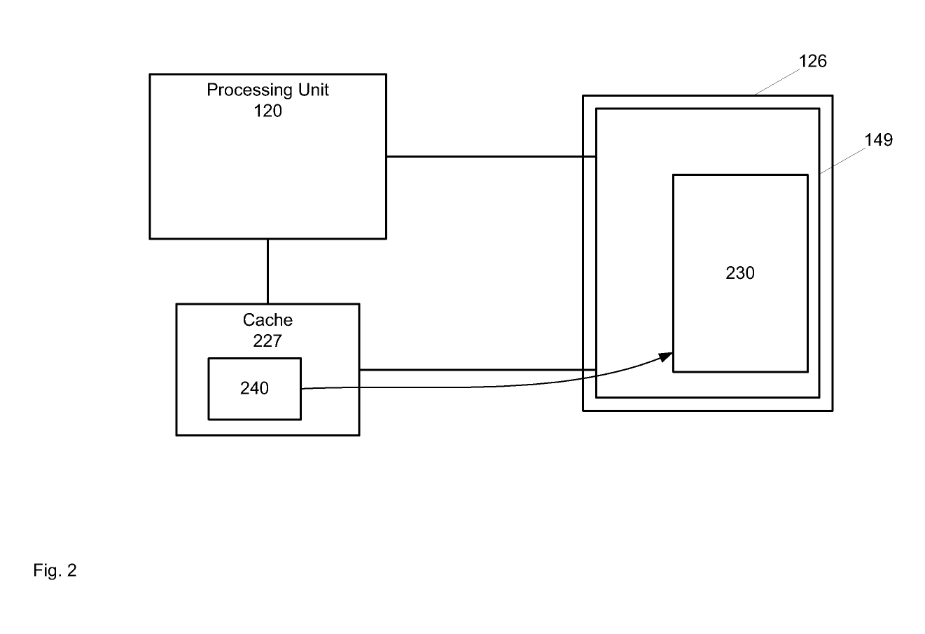

In particular, attention is directed to FIG. 2 which depicts non-limiting implementations of display device 126 and circuitry 149, in communication with processing unit 120 and a memory cache 227 (hereinafter cache 227). In some implementations, memory device 124 can include cache 227, while in other implementations cache 227 can include a separate memory device. Furthermore, processing unit 120 is in communication with cache 227 and further enabled to control circuitry 149. In particular, processing unit is enabled to control an area 230 of circuitry 149 to provide rendering 150. Data 240 is stored in cache 227, data 240 including data for controlling area 230 to provide rendering 150; when rendering 150 is to be provided at display 126, data 240 is transferred to display 126 to control circuitry 230.

In implementations depicted in FIG. 2, it is appreciated that circuitry 149 and area 230 includes, for example, transistors in a flat panel display; however, in other implementations, circuitry 149 can include a combination of an electron gun in a CRT, and area 230 can include phosphors in a CRT.

In some implementations device 101 further includes a clock device 127, including any suitable electronic and/or digital clock device. It is appreciated that processor 120 is interconnected with clock device 127 (e.g. via a computer bus, not depicted) such that processor 120 can retrieve times and/or dates from clock device 127 and thereby determine when a given time period has passed.

In some implementations, device 101 can further include any suitable combination of other hardware and/or software components, including but not limited to a GPS (Global Positioning System) device, an accelerometer, a light sensor, a compass sensor, an address book, a messaging application, a media application a calendar application, and the like.

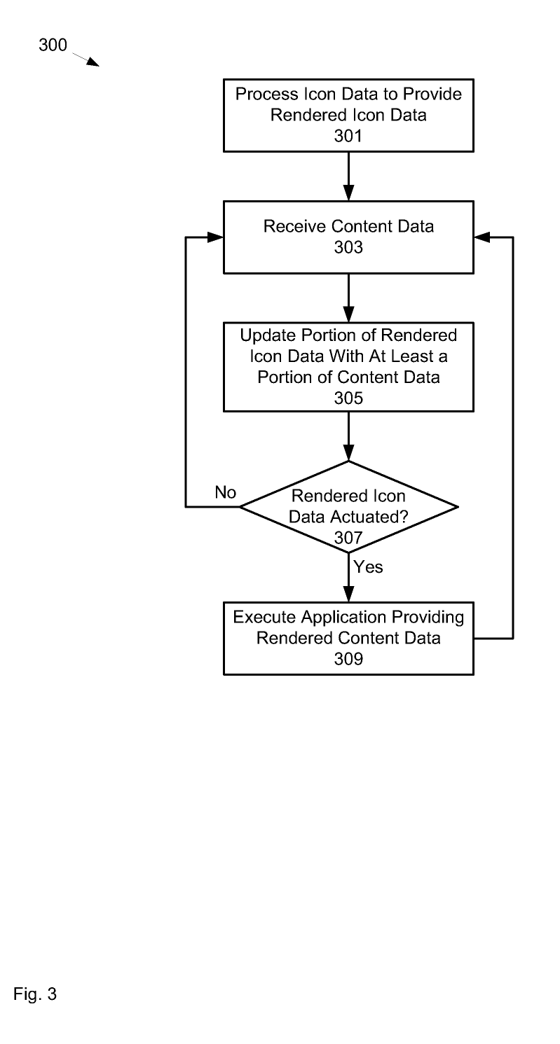

Attention is now directed to FIG. 3 which depicts a flow diagram of a method 300 for processing content data at a computing device. In order to assist in the explanation of method 300, it will be assumed that method 300 is performed using system 100. Furthermore, the following discussion of method 300 will lead to a further understanding of system 100 and its various components. However, it is to be understood that system 100 and/or method 300 can be varied, and need not work exactly as discussed herein in conjunction with each other, and that such variations are within the scope of present implementations.

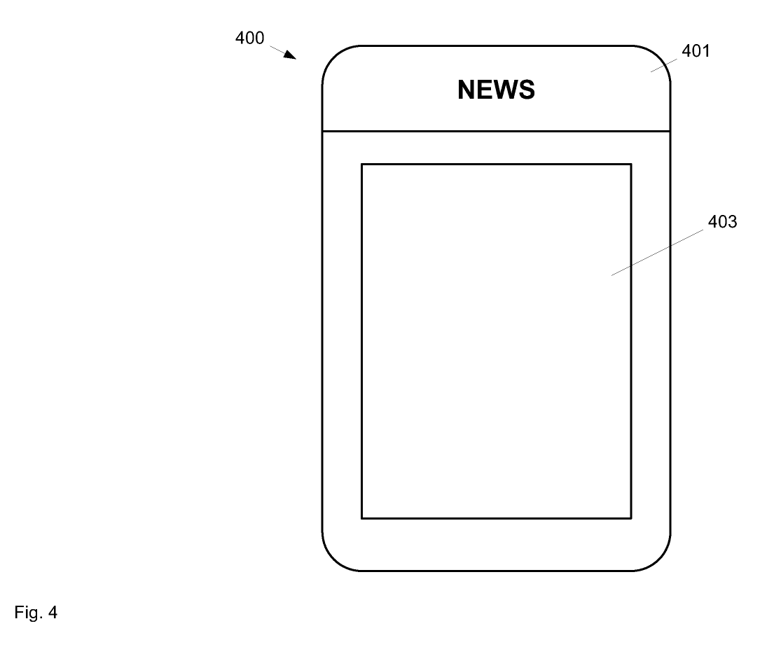

At block 301, icon data 140 associated with application 140 is rendered at display device 126, thereby providing rendered icon data 400 at display device 126. A non-limiting implementation of rendered icon data 400, also referred to hereafter as icon 400, is depicted in FIG. 4. In some implementation rendering 150 includes icon 400. It is appreciated that icon 400 can include a header portion 401 and a content portion 403. It is further appreciated that header portion 401 includes an identifier of associated application 142 and/or an identifier of a type of content data 107: for example, as depicted in FIG. 4, header portion 401 includes the text “News”, indicating that when icon 400 is actuated (e.g. via input device 125) a “News” application will be launched by executing application 142 (i.e. application 142 can include a news application) and news content will be provided therein.

Content portion 403 is enabled to provide at least a subset of content data 107. However, as content data 107 has not yet been received, in FIG. 4 content portion 403 is not populated. Hence, in FIG. 4, icon 400 appears similar to a static icon.

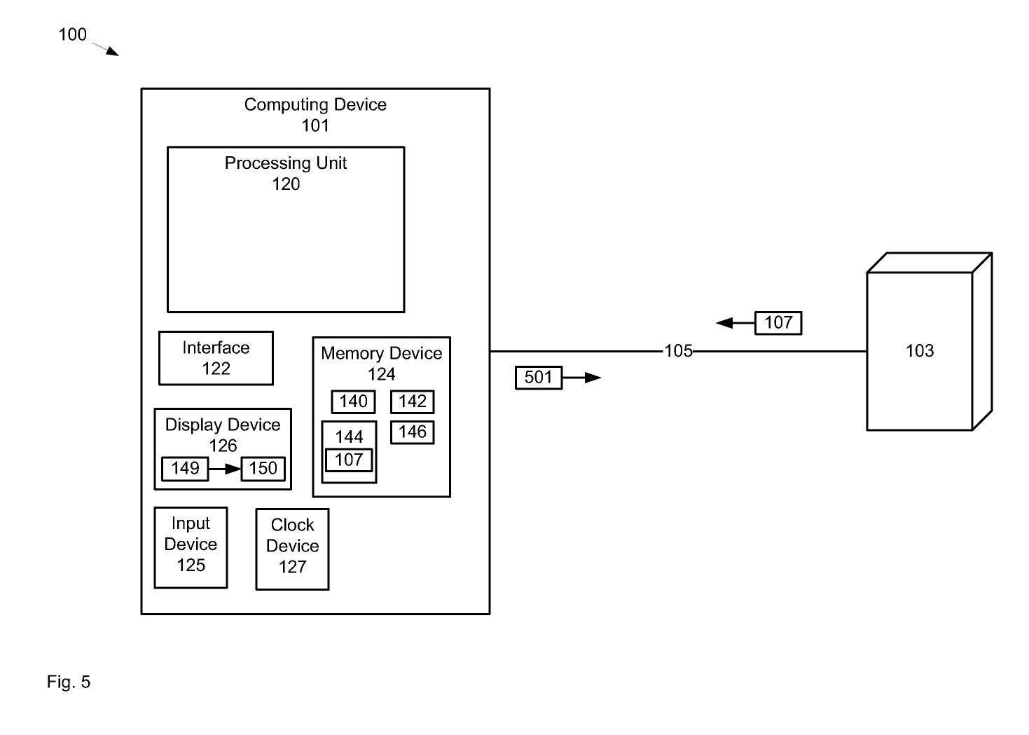

Returning to FIG. 3, at block 303 content data 107 is received. In some implementations content data 107 is received in response to device 101 transmitting a request 501 to server 103 via interface 122 and/or link 105. For example, application 146 (and/or any other suitable application) can be enabled to periodically request updates from server 103. Server 103 responds to request 501 by transmitting content data 107 to device 101 via link 105, as depicted in FIG. 5 (substantially similar to FIG. 1, with like elements having like numbers).

However, in other implementations content data 107 can be received in a push operation of content data 107 from server via communication interface 122. For example server 103 can be enabled to transmit content data 107 periodically and/or as changes occur to data monitored and/or stored by server 103. It is contemplated, for example, that server 103 can be enabled to electronically monitor a stock price; when the stock price changes, content data 107 is transmitted to device 101. Any other trigger for transmitting and/or pushing content data 107 to device 101 is within the scope of present implementations.

Further, in some implementations, content data 107 can be received from a server associated with an external service. For example, whether in push implementations or on implementations where content data 107 is requested by device 101, server 103 can retrieve content data 107 from another server (not depicted) associated with an external service, such as news service, a stock exchange, or the like.

In yet further implementations, content data 107 can be received from at least one hardware and/or software component of device 101, including but not limited to at least one of a GPS (Global Positioning System) device, an accelerometer, a light sensor, an address book, a messaging application, a calendar application and the like. In some of these implementations, components of device 101 can be accessed via an API (application programming interface).

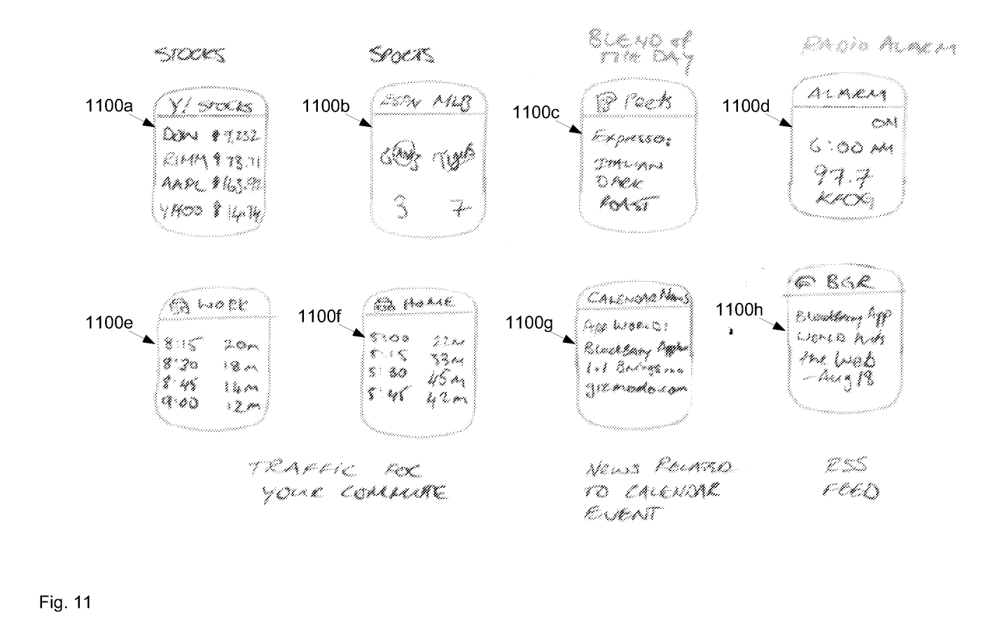

In yet further implementations, content data 107 can be received from input device 125. For example in implementation where application 142 includes an alarm clock application, a time to trigger the alarm clock application (e.g. to provide an alarm) can be received from input device 125, as well as any other suitable data, such as a radio station to tune to provide as the alarm (e.g. see icon 1100d described below with reference to FIG. 11).

It is yet further appreciated that content data 107 is associated with application 142 and that content data 107 can be rendered within application 142 when application 142 is executed by processor 120 and rendered at display device 126. For example, returning to the example of application 142 including a news application, content data 107 can include news data for display in the news application once news application is executed by processor 120 and rendered at display device 126.

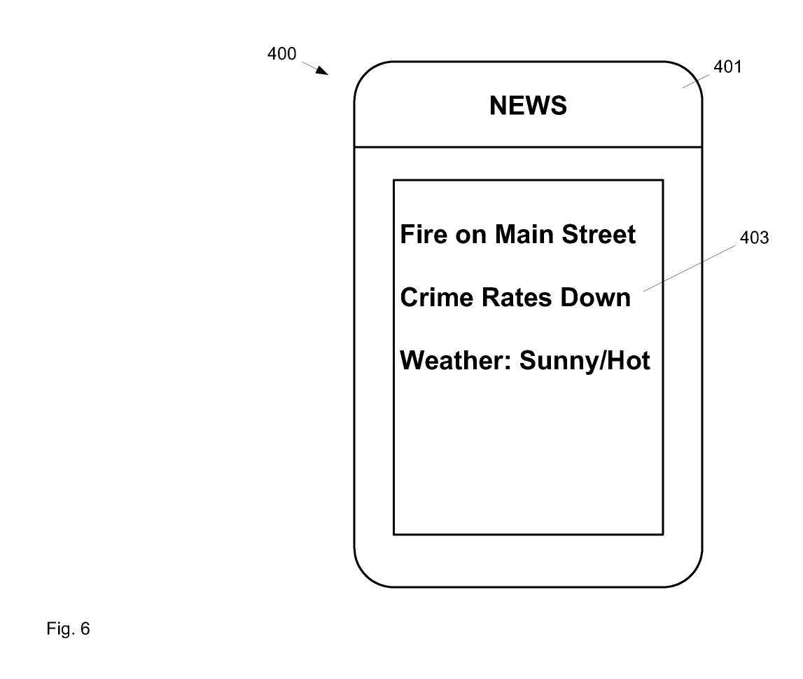

Returning now to FIG. 3, at block 305 a portion of rendered icon data 400 is updated such that rendered icon data 400 includes at least a subset of content data 107. With reference to FIG. 6, which is substantially similar to FIG. 4 with like elements having like numbers, in some implementations, content portion 403 of icon 400 is updated with at least a subset of content data 107. For example, content data 107 can include text such as “NEWS FOR APR. 27, 2010, HEADLINES: Fire on Main Street, Crime Rates Down, Weather Sunny/Hot”, followed by each story indicated in the headlines. However only the headlines are provided in content portion 403 of icon 400 and the other data is not provided. Rather, content data 107 is stored in resource file 144 for later access by application 142, as depicted in FIG. 5. For example, content data 107 can be stored in resource file 144, such that content data 107 can be retrieved from resource file 144 when application 142 is executed by processor 120.

In some implementations, content data 107 includes HTML (Hypertext Markup Language) data intended for display in application 142, and tags in the HTML data can be used to determine which portion of content data 107 is provided in icon 400. However content data 107 can include any suitable format, and the format of content data 107 is not to be considered particularly limiting. Content data 107 can further include any suitable combination of text, images, or the like, each in any suitable format.

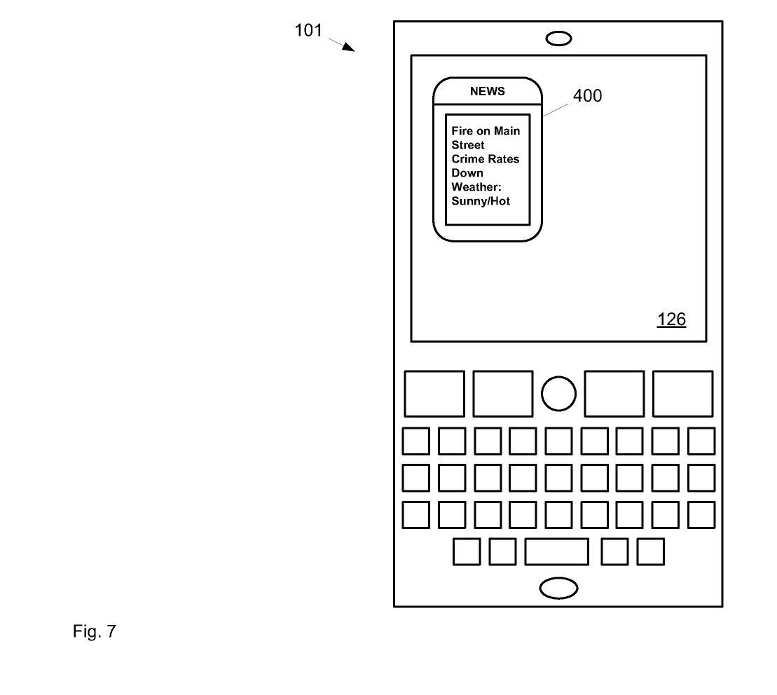

Attention is now directed to FIG. 7, which depicts a perspective view of device 101 with icon 400 rendered at display device 126. It is further appreciated that icon 400 can be provided on a home screen of device 101, such that icon 400 is generally provided unless an application and/or a screen other than a home screen is being provided.

It is appreciated that in FIG. 7, icon 400 is providing at least a portion of content data 400 and that full content data 107 can be provided in application 142 upon actuation of icon 400. Specifically, returning to FIG. 3, at block 307 it is determined whether icon 400 has been actuated. If not, further content data can be received at block 303 as described above, and icon 400 can be updated again at block 305. Indeed, blocks 303 and 305 can be repeated any suitable number of times until it is determined at block 307 that icon 400 has been actuated.

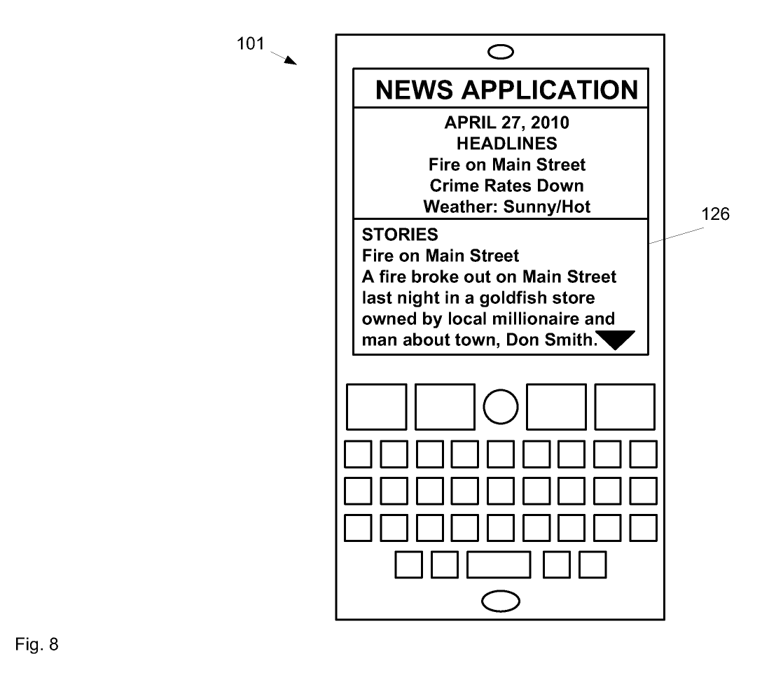

When icon 400 is actuated, at block 309, application 142 is responsively executed at processor 120 such that content data 107 is rendered at display device 126 within a rendering of application 142, as depicted in FIG. 8. FIG. 8 is substantially similar to FIG. 7 with like elements having like numbers, however in FIG. 8 icon 400 has been actuated, application 142 has been executed, content data 107 has been retrieved from resource file 144, and application 142 and content data 107 have been rendered at display device 126.

It is appreciated that application 142 remains unexecuted until icon 400 is actuated. In other words, rendering of icon 400, and rendering of at least a portion of content data 107 in icon 400 can occur independently of execution of application 142.

However, in further implementations, application 142 rendering of icon 400, and/or rendering of at least a portion of content data 107 in icon 400 can occur while application 142 is being executed in the background (e.g. processed by processor 120 but not rendered at display device 126), in the foreground, or the like.

It is further appreciated that blocks 303 to 307 are repeated there after, and that application 142 can thereafter be closed, minimized, or the like. Indeed, it is appreciated that in some implementations, blocks 303 to 307 can be repeated independent of whether or not application 142 is closed and/or minimized, and/or whether or not application 142 remains open.

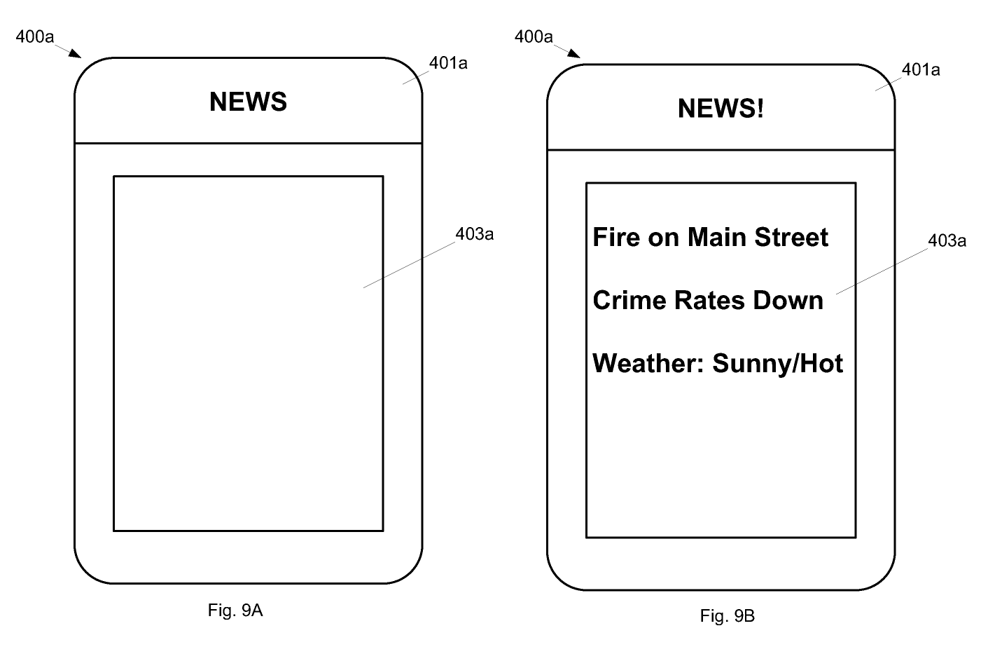

In some implementations, header portion 401 is static and does not change when content portion 403 is updated, for example as depicted in FIGS. 4, 6 and 7. However, in other implementations, header portion 401 is dynamic, such that content of header portion 401 changes based on content data 107. For example, FIG. 9A depicts an icon 400a similar to icon 400, with like elements having like numbers with an “a” appended thereto. However, header portion 400a is dynamic. For example, FIG. 9B depicts icon 400a once content data 107 has been received. It is appreciated that content portion 403a has been updated similar to icon 400 in FIG. 6. However, it is further appreciated header portion 401a has also been updated from “NEWS” to “NEWS!”, thereby indicating that content portion 403a has been updated. In some implementations, after a given time period, header portion 401a can return to the state depicted in FIG. 9A when no new content data 107 is received and/or when no new content portion 403a has been received in the given time period.

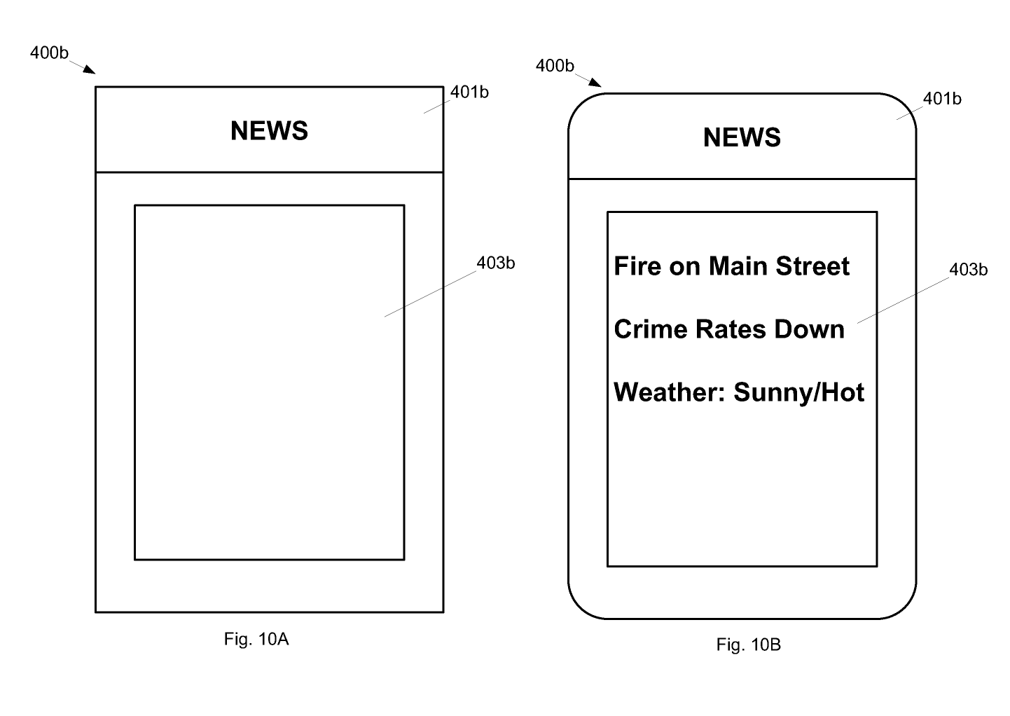

In some implementations, the shape of icon 400 is static. However, in other implementations, the shape of icon 400 is dynamic, such that content of header portion 401 changes based on content data 107, and/or with time. For example, FIG. 10A depicts an icon 400b similar to icon 400, with like elements having like numbers with a “b” appended thereto. However, the shape of icon 400 is dynamic. For example, it is appreciated that icon 400b has square corners. However, once content data 407 is received and/or content portion 403b is updated, the corners of icon 400b change to rounded corners as in FIG. 10B. In some implementations, after a given time period, the shape of icon 400b can change back to square corners, either abruptly or slowly (e.g. in an animation) indicating that the content of content portion 403b is no longer fresh. Indeed, any change in shape and/or type of change and/or mechanism for changing shape of icon 400b is within the scope of present implementations.

It is further appreciated that method 300 can be repeated for any suitable number of icons and associated applications such that any suitable number of icons that are updated to provide content data from the same or different server and/or from components at device 101 are rendered at display device 126.

For example, FIG. 11 depicts non-limiting examples of different icons 1100a-1100h that can be rendered at display device 126. Each of icons 1100a-1100h is similar to icon 400 but associated with different applications stored in memory 124. Further, each icon 1100a-1100h is updated as respective associated content data is received; and each respective associated application is launched when the respective icon 1100a-1100h is actuated. For example, icon 1100a is associated with a stock application and stock data is provided in icon 1100a, the stock application being launched when icon 1100a is actuated. Icon 1100b is associated with a sports application and sports data is provided in icon 1100b, the sports application being launched when icon 1100b is actuated. Icon 1100c is associated with an application showing products available at a coffee shop (e.g. “Blend of the Day”) and product data is provided in icon 1100c, the coffee shop application being launched when icon 1100c is actuated. Icon 1100d is associated with an alarm clock application and alarm data is provided in icon 1100d, the alarm clock application being launched when icon 1100d is actuated; it is appreciated in this implementation that the associated content data can be received from an API and/or a component of device 101 and/or data stored in device 101. Icons 1100e and 1100f are each associated with a traffic application that provides estimated commute times for going to work and returning home from work, the estimated commute times provided in icon 1100a, the traffic application being launched when either of icon 1100e or 1100f is actuated. Icon 1100g is associated with a news application related to calendar events and news data is provided in icon 1100g, the news application being launched when icon 1100g is actuated. Icon 1100h is associated with an RSS (Really Simple Syndication) application and RSS data is provided in icon 1100h, the RSS application being launched when icon 1100h is actuated.

Any other types of icons and associated applications are within the scope of present implementations. In a non-limiting example, a GPS device could determine location and present associated content in an icon similar to icon 400, such as “You Are Now Home” in the icon: i.e. an indication of current location is provided.

In yet a further non-limiting example, an icon associated with a telephone application could be provided; another associated address book and/or e-mail monitoring application could be enabled to keep track of e-mail addresses to which messages are most often sent, and the icon could present a phone number associated with the most often mailed e-mail address; actuation of the icon could then launch the phone application, dialing the provided number. Hence, in this implementation content data is received from another application at device 101 and stored in an associated resource file.

Indeed, such coupling to other applications is also contemplated. For example, an e-mail monitoring application and/or an RSS feed (or news) monitoring application could be enabled to monitor accessed and/or stored content at device 101, and an icon associated with a phone application and/or a news application could be updated based on the monitored data. In other words content data is received from the coupled application. For example, the monitoring application could determine that many e-mails complaining about an oil spill have received/transmitted and/or the monitoring application could determine that RSS feeds or news content is being accessed about the oil spill. In response, the monitoring application could determine the phone number of a politician to which complaints could be sent and provide content data including the e-mail address and/or phone number of the politician, Hence, upon actuation of the icon, a messaging and/or phone application could be launched providing access to the politician via e-mail and/or phone.

Various advantages will now be apparent. For example, rendering of content data in “live” icons, such as icon 400 provides a convenient means of accessing content data delaying launch of the associated application until the provided content data indicates a need to launch the associated application, for example to access more details of the provided content data. This can lead to a reduction in processing resources at device 101, as well as an increase in battery life as processing of applications is generally more resource intensive than updating of icons as described herein. Furthermore, more efficient use of cache 227 due to delaying launch of the associated application as the associated application will generally consume more of cache 227 resources.

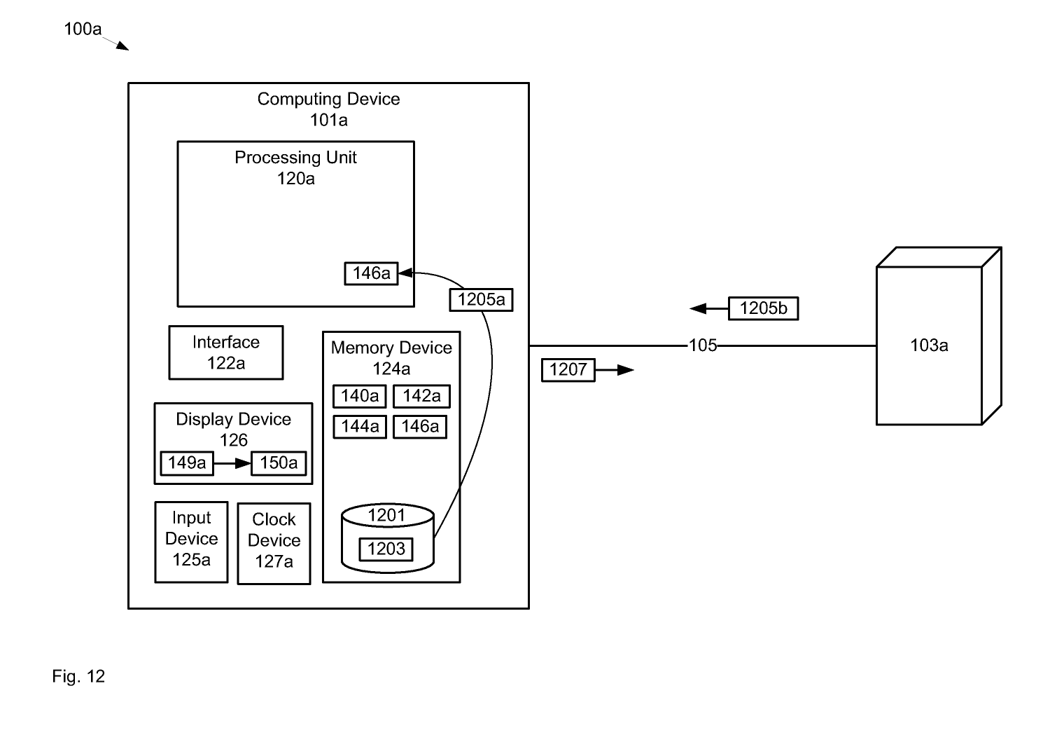

Attention is now directed to FIG. 12 which depicts a system 100a for processing context data, according to non-limiting implementations. System 100a is substantially similar to system 100, with like elements having like numbers. However, device 101a further includes a calendar database 1201 storing calendar event data 1203. It is appreciated that calendar event data 1203 can include data associated with at least one calendar event, and that calendar event data 1203 can further include the calendar of a user associated with device 101a.

Application 146a is generally enabled to periodically retrieve at least a first portion of context data 1205a from calendar database 1201 (referred to hereafter as database 1201) when application 146a is being processed by processing unit 120a. The at least a first portion of context data 1205a can be used to update a representation 150a of icon data 140a. The at least a first portion of context data 1205a will also be referred to hereafter as data 1205a.

For example, application 146a can be enabled to retrieve data 1205a periodically and/or at pre-determined times according to clock device 127a. In some implementations, a time that data 1205a is to be retrieved can be pre-configured in application 146a, while in other implementations, a time that data 1205a is to be retrieved can be determined via application 142a: in these implementations, a time to retrieve data 1205a can be determined at a last time application 142a was processed and stored in resource file 144a. However any suitable method for determining when to retrieve data 1205a from database 1201 is within the scope of present implementations.

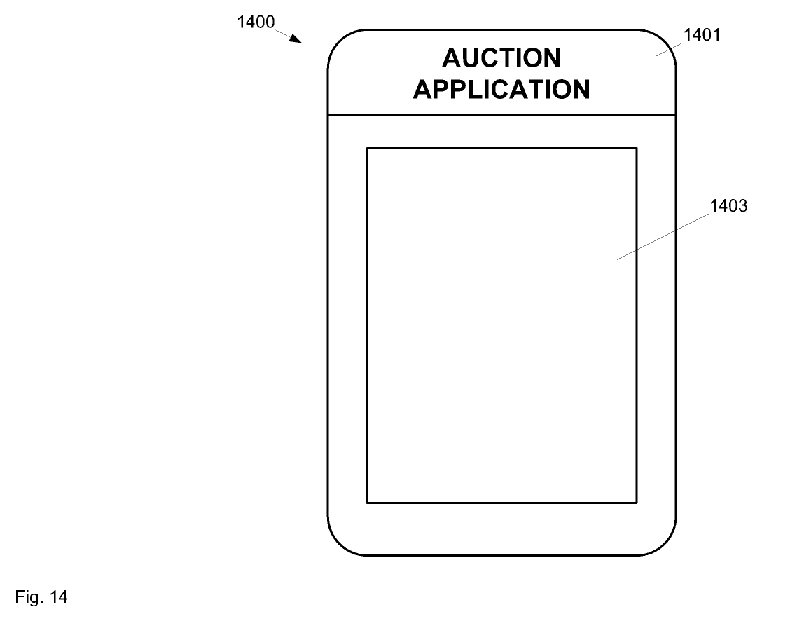

In some implementations, application 146a can further retrieve at least a second portion of context data 1205b from content server 103a by transmitting a request 1207 for at least a second portion of context data 1205b based on least one of a current time and data 1205b. These implementations can be further understood with reference to examples provided below with reference to FIGS. 14-18. The at least a second portion of context data 1205b will also be referred to hereafter as data 1205b.

In any event once data 1205a, and in some implementations data 1205b, is retrieved, a representation 150a of icon data 140a can be updated with data 1205a (and/or data 1205b) similar to updating a portion of rendered icon data 400 described above.

Hereafter, context data 1205a, 1205b will be collectively referred to as context data 1205.

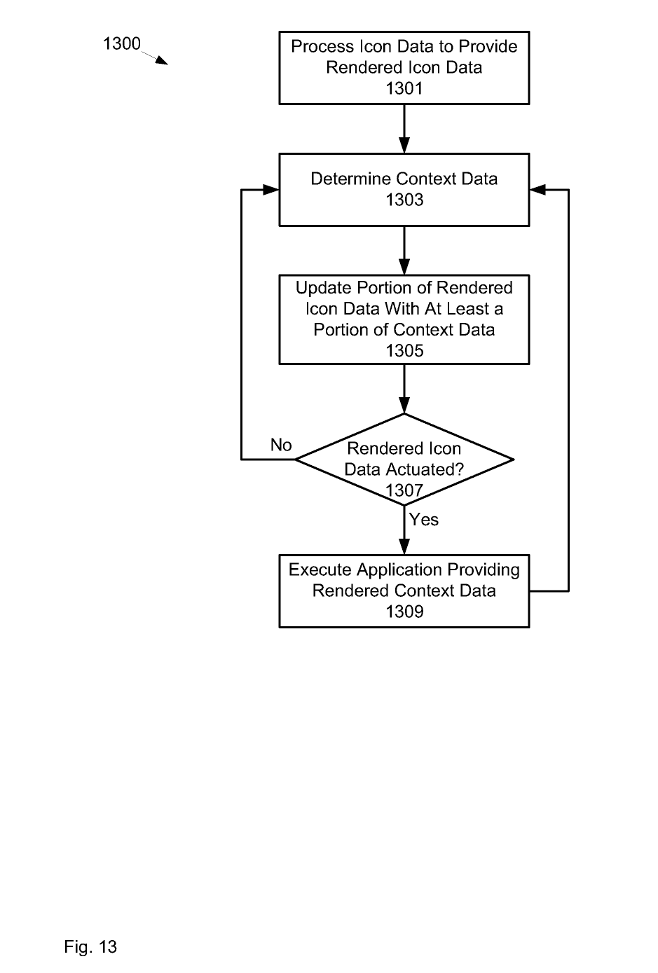

Attention is now directed to FIG. 13 which depicts a flow diagram of a method 1300 for processing context data at a computing device. In order to assist in the explanation of method 1300, it will be assumed that method 1300 is performed using system 100a. Furthermore, the following discussion of method 1300 will lead to a further understanding of system 100a and its various components. However, it is to be understood that system 100a and/or method 1300 can be varied, and need not work exactly as discussed herein in conjunction with each other, and that such variations are within the scope of present implementations.

It is appreciated that method 1300 is substantially similar to method 300 described above with like elements having like numbers. For at block 1301, icon data 140a is processed to provide rendered icon data 1400, as depicted in FIG. 14, rendered icon data 1400 similar to rendered icon data 400. However, at block 1303 context data 1205 is determined as described above and with reference to FIGS. 14-18 below, and at block 1305, a portion of rendered icon data 1400 is updated with at least a portion of context data 1205. Further, upon actuation of rendered icon data 1400 at block 1307, the next block is 1309, where application 142a is executed providing rendered context data. If rendered icon data 1400 is not actuated at block 1307, the next block is 1303.

Attention is now directed to FIG. 14 which depicts rendered icon data 1400 including a header portion 1401 and a content portion 1403, respectively similar to header portion 401 and content portion 403 described above. However it is appreciated that rendered icon data 1400 is associated with an auction application in this example embodiment (i.e. in these implementations, application 142a includes an auction application).

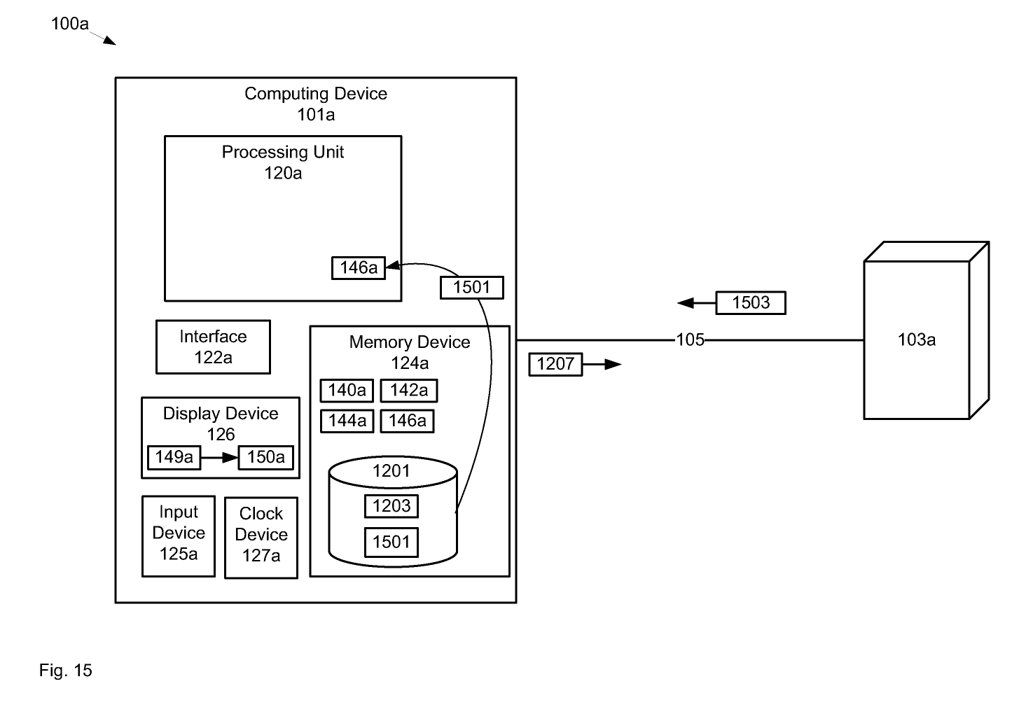

Attention is next directed to FIG. 15, which is substantially similar to FIG. 12 with like elements having like numbers. However in FIG. 15, auction event data 1501 associated with the auction application has been added to database 1201 so that at least one item up for auction at an auction server can be watched. For example, it is understood that the auction application is enabled to retrieve data from an auction server (e.g. content server 103a) and that auction event data 1501 is associated with an item up for auction at the auction server. Application 146a (e.g. a Context Platform) accessed database 1201 as described above and identifies auction event data 1501 associated with rendered icon data 1400. Hence, in these implementations context data 1205a includes auction event data 1501. In some implementations application 146a makes the retrieved auction event data 1501 available for Context JavaScript APIs.

Application 146a can then retrieve further auction data 1503 from the auction server (i.e. content server) using auction event data 1501. In other words request 1207 can include at least a portion of data 1501 identifying a specific item up for auction and/or identifying device 101a and/or a user associated with device 101a (e.g. via a user-name data) such that further auction data 1503 can be retrieved. It is appreciated that further auction data 1503 is associated with at least one of device 101a, a user of device 101a, an identifier of device 101a, an identifier of the user of device 101a, or the like. In some implementations, further auction data 1503 includes data associated with a soonest ending item on watch list and/or a list of auctions associated with device 101a or the like.

In any event, in a next refresh cycle, rendered icon data 1400 is updated such that content portion 1401 provides at least a portion of data 1501, 1503 (i.e. context data). In some implementations a Context JavaScript API can cause rendered icon data 1400 to be updated.

Upon actuation of rendered icon data 1400, the auction application can access the auction server and resource file 144a to provide more auction data and/or enable bidding on a given auctioned item.

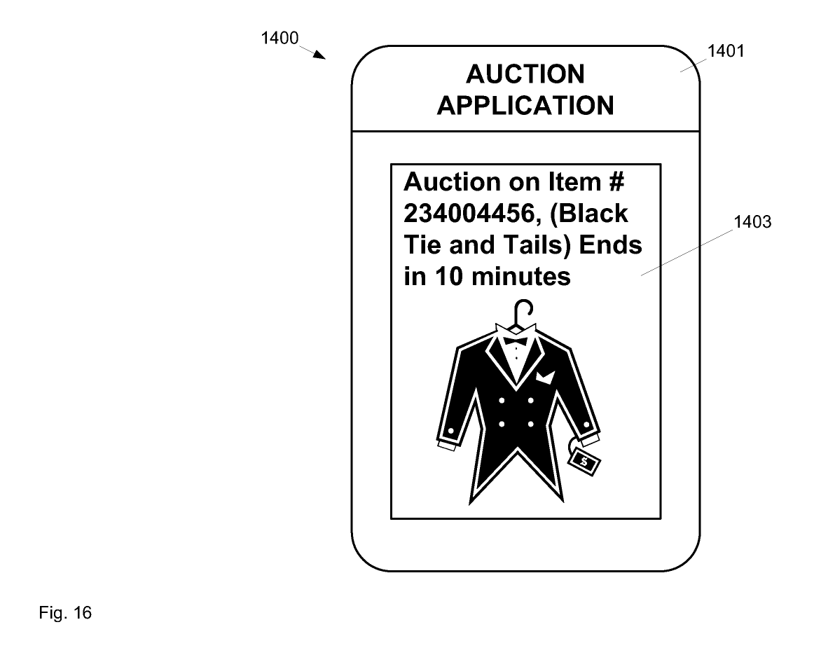

For example, attention is directed to FIG. 16 which depicts rendered icon 1400 with content portion 1403 updated to provide at least of portion of data 1501, 1503 (i.e. context data).

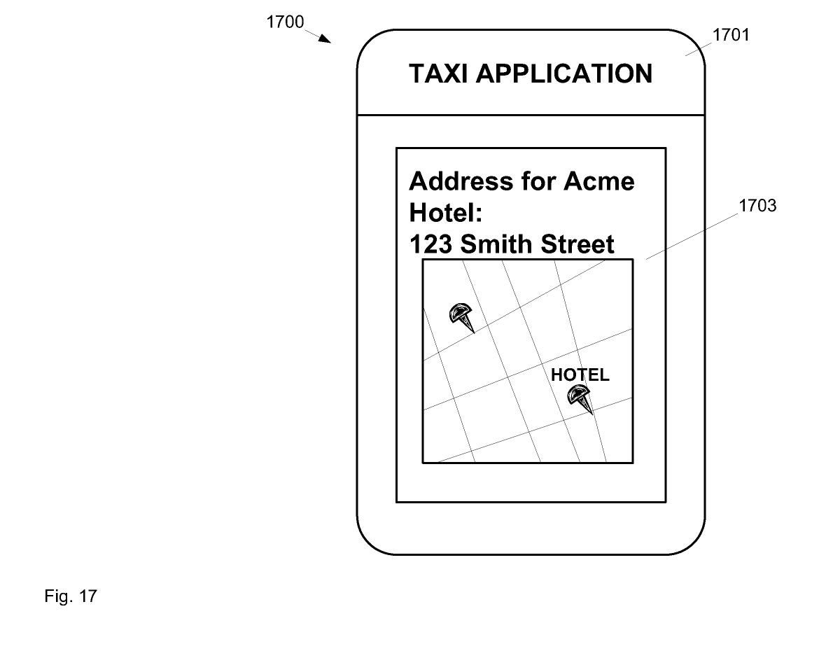

A further non-limiting example is provided in FIG. 17, which depicts a rendered icon data 1700, similar to rendered icon data 1400, with like elements having like numbers, however preceded by “17” rather than “14”. Hence header portion 1701 is similar to header portion 1401. However, rendered icon data 1700 is associated with a taxi application for finding taxis at a given location. For example, in these implementations, application 142a can include the taxi application which, when processed, determines at least one of a present location and a destination location, and then provided access to taxi services available at the present location and/or taxi services available to reach the destination location (e.g. local taxi phone numbers are provided).

In any event, application 146a can access database 1201 to determine a next location (e.g. context data 1205a with reference to FIG. 12). For example, application 146a can access clock device 127a to determine a current time, and then access database 1201 to determine a next calendar event occurring at and/or after the current time, and whether or not the next calendar event is associated with a location. For example, in example implementations, a current time can be 3 pm and a next calendar event at and/or after 3 pm can be “Check-In to Acme Hotel”. In some implementations the location (e.g. street address) of the Acme Hotel can be either provided in a the next calendar event, while in other implementations the location of the Acme Hotel can be retrieved from content server 103a (which in these implementations can include at least one of a map server, a content server for the taxi application, an address server, or the like) in data 1205b.

Then, at least a portion of context data 1205 can be provided in content portion 1703, for example the name of the location (“Acme Hotel”), a street address of the location (“123 Smith Street”), and/or a map of the street address. In implementations where a map is provided, the map can include a current location which can be determined from a GPS device (not depicted) and/or through triangulation methods.

Further, upon actuation of rendered icon data 1700, the taxi application is processed and at least a portion of the context data 1205 can be accessed from resource file 144a and/or transmitted to a server servicing the taxi application so that the taxi application can provide taxi data for reaching the location.

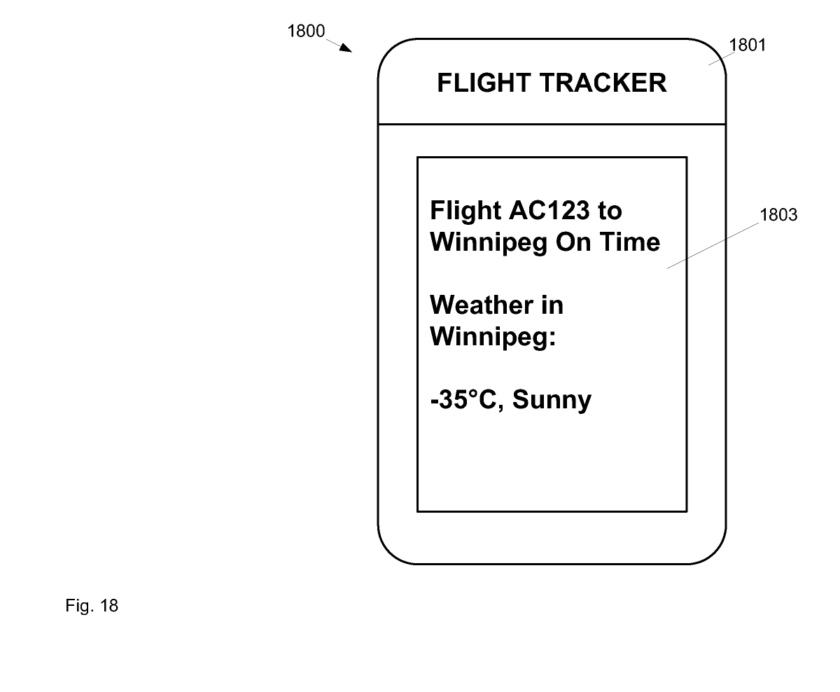

A further non-limiting example is provided in FIG. 18, which depicts a rendered icon data 1800, similar to rendered icon data 1400, with like elements having like numbers, however preceded by “18” rather than “14”. Hence header portion 1801 is similar to header portion 1401. However, rendered icon data 1800 is associated with a flight tracker application for tracking flight status. For example, in these implementations, application 142a can include the flight tracker application which, when processed, determines the status of a given flight and/or the weather at the destination location of the given flight.

In any event, application 146a can access database 1201 to determine a next flight (e.g. context data 1205a with reference to FIG. 12). For example, application 146a can access clock device 127a to determine a current time, and then access database 1201 to determine a next calendar event including a flight number occurring at and/or after the current time. For example, in example implementations, a current time can be 3 pm and a next calendar event at and/or after 3 pm can include a flight number “AC123”. The status of flight number AC123 can then be retrieved from content server 103a (in these implementations at least one of an airline server and/or a server servicing application 146a and/or application 142a).

In some implementations, weather at a destination of flight number AC123 can be retrieved from content server 103a (or another suitable content server). The destination can be determined from the next calendar event and/or from content server 103a using the flight number (e.g. request 1207 includes the flight number). Once the destination has been determined, in some implementations, the destination weather can be retrieved from a weather server via another request. In further implementations, content server 103a can act as a proxy to retrieve the destination weather and provide associated data in context data 1205b.

Regardless of the source of the weather data, at least a portion of context data 1205 can be provided in content portion 1803, for example the flight number, an identifier of the destination, and/or the weather at the destination location.

Further, upon actuation of rendered icon data 1800, the flight tracker application is processed and at least a portion of the context data 1205 can be accessed from resource file 144a and/or transmitted to a server servicing the flight tracker application so that the flight tracker application can provide more detailed flight data.

It is further appreciated that in some of these implementations, rendered icon data 1400, 1700, 1800 are updated with a mixture of context data and content data.

It is yet further appreciated that while rendered icon data 1400, 1700, 1800 includes context data retrieved from both database 1201 and content server 103a, in other implementations rendered icon data can include context data retrieved only from database 1201, and/or another data source local to device 101a. In further implementations, rendered icon data can include context data retrieved only from at least one remote data source and/or a plurality of remote data sources, e.g. via a suitable combination of links such as links 105, 105a and/or networks.

Further while only one application 146a for updating rendered icon data is depicted at device 101a, it is appreciated that each set of rendered icon data that is to be updated can be associated with an associated updating application in a one-to-one relationship.

It is yet further appreciated that in some implementations rendered icon data 1400, 1700, 1800 can be dynamically changed based on user and device context changes. For example, as the context of device 101a and/or an associated user changes, each of rendered icon data 1400, 1700, 1800 can be updated to reflect the context. For example, in rendered icon data 1400 data associated with a new/next item can be provided; in rendered icon data 1700 data associated with a new/next destination location can be provided for a next calendar event once the current destination is reached; and in rendered icon data 1800, data associated with a new/next flight can be provided once an arrival time of a current flight is passed. However, it is understood that rendered icon data 1400, 1700, 1800 can be updated using any suitable method and at any suitable, determinable, change in context.

It is yet further appreciated that in non-limiting implementations, applications for updating rendered icon data 1400, 1700, 1800 can be developed in HTML associated with JavaScript, AJAX (Asynchronous JavaScript and XML) and CSS (Cascading Style Sheets). For example, applications for updating rendered icon data 1400, 1700, 1800 can utilize any suitable Context APIs exposed as JavaScript by a device context platform. Further a Context Platform can extend a JavaScript engine and provide context information as JavaScript APIs. Applications for updating rendered icon data 1400, 1700, 1800 can use context JavaScript APIs to update rendered icon data 1400, 1700, 1800 content based on different contexts.

Various advantages will now be apparent. For example, rendering of context data in “live” icons, such as icons 1400, 1700, 1800 provides a convenient means of accessing context data delaying launch of the associated application until the provided context data indicates a need to launch the associated application, for example to access more details of the provided context data. This can lead to a reduction in processing resources at device 101a, as well as an increase in battery life as processing of applications is generally more resource intensive than updating of icons as described herein. Furthermore, more efficient use of an associated cache (similar to cache 227) due to delaying launch of the associated application as the associated application will generally consume more of cache resources.

Those skilled in the art will appreciate that in some implementations, the functionality of devices 101, 101a can be implemented using pre-programmed hardware or firmware elements (e.g., application specific integrated circuits (ASICs), electrically erasable programmable read-only memories (EEPROMs), etc.), or other related components. In other implementations, the functionality of device 101, 101a can be achieved using a computing apparatus that has access to a code memory (not shown) which stores computer-readable program code for operation of the computing apparatus. The computer-readable program code could be stored on a computer readable storage medium which is fixed, tangible and readable directly by these components, (e.g., removable diskette, CD-ROM, ROM, fixed disk, USB drive). Furthermore, it is appreciated that the computer-readable program can be stored as a computer program product including a computer usable medium. Further, a persistent storage device can include the computer readable program code. It is yet further appreciated that the computer-readable program code and/or computer usable medium can include a non-transitory computer-readable program code and/or non-transitory computer usable medium. Alternatively, the computer-readable program code could be stored remotely but transmittable to these components via a modem or other interface device connected to a network (including, without limitation, the Internet) over a transmission medium. The transmission medium can be either a non-mobile medium (e.g., optical and/or digital and/or analog communications lines) or a mobile medium (e.g., microwave, infrared, free-space optical or other transmission schemes) or a combination thereof.

FIGS. 3 and 13 are flow diagrams illustrating methods for processing content data and context data, in accordance with example embodiments of the present disclosure. Some of the steps illustrated in the flow diagrams may be performed in an order other than that which is described. Also, it should be appreciated that not all of the steps described in the flow charts are required to be performed, that additional steps may be added, and that some of the illustrated steps may be substituted with other steps.

A portion of the disclosure of this patent document contains material which is subject to copyright protection. The copyright owner has no objection to the facsimile reproduction by any one the patent document or patent disclosure, as it appears in the Patent and Trademark Office patent file or records, but otherwise reserves all copyrights whatsoever.

Persons skilled in the art will appreciate that there are yet more alternative variations and modifications possible for present implementations, and that the above implementations and examples are only illustrations of one or more implementations.

What is claimed is:

1. A method for processing context data at a communication device, the communication device comprising a processor interconnected with a memory, a display device and a communication interface, the method comprising:
rendering icon data associated with an application at the display device, thereby providing rendered icon data at the display device, the icon data and the application stored at the memory;
determining context data associated with the application by retrieving at least a first portion of the context data from a calendar database, the context data for rendering within the application when the application is executed by the processor and rendered at the display device;
updating a portion of the rendered icon data such that the rendered icon data comprises at least a subset of the context data; and
when the rendered icon data is actuated, responsively executing the application at the processor such that the context data is rendered at the display device within a rendering of the application.

2. The method of claim 1, wherein the application remains unexecuted until the processor responsively executing the application.

3. The method of claim 1, wherein the rendered icon data comprises at least one of a header portion and a content portion; the portion of the rendered icon data that is updated comprising the content portion.

4. The method of claim 3, wherein the header portion is one of:
static; or
dynamic, such that content of the header changes based on the context data.

5. The method of claim 1, wherein a shape of the rendered icon data is one of:
static; or
dynamic, such that the shape changes based on at least one of the context data and time.

6. The method of claim 1, wherein the context data comprises at least one of HTML (hypertext markup language) data, HTML tags, text data and image data.

7. The method of claim 1, wherein the determining the context data further occurs by at least one of:
retrieving the at least a first portion of the context data from the calendar database based on a current time;
requesting at least a second portion of the context data from a content server based on at least one of the first portion of the context data and the current time;
receiving the at least a second portion of the context data from the content server; and
an API (application programming interface).

8. The method of claim 1, wherein the determining the context data occurs via an API (application programming interface) that interfaces with at least one of the calendar database and a remote content server.

9. The method of claim 1, further comprising storing the context data in a resource file associated with the application, such that the context data can be retrieved from the resource file when the application is executed.

10. The method of claim 1, further comprising requesting content data from a content server based on at least one of at least a portion of the context data and a current time, and wherein the updating the portion of the rendered icon data further comprises updating the portion of the rendered icon data using at least a subset of the content data.

11. A communication device for processing context data, comprising:
a processor interconnected with a memory, a display device and a communication interface, the processor enabled to:
render icon data associated with an application at the display device, thereby providing rendered icon data at the display device, the icon data and the application stored at the memory;
determine context data associated with the application by retrieving at least a first portion of the context data from a calendar database, the context data for rendering within the application when the application is executed by the processor and rendered at the display device;
update a portion of the rendered icon data such that the rendered icon data comprises at least a subset of the context data; and
when the rendered icon data is actuated, responsively execute the application such that the context data is rendered at the display device within a rendering of the application.

12. The communication device of claim 11, wherein the application remains unexecuted until the processor responsively executing the application.

13. The communication device of claim 11, wherein the rendered icon data comprises at least one of a header portion and a content portion; the portion of the rendered icon data that is updated comprising the content portion.

14. The communication device of claim 13, wherein the header portion is one of:
static; or
dynamic, such that content of the header changes based on the context data.

15. The communication device of claim 11, wherein a shape of the rendered icon data is one of:
static; or
dynamic, such that the shape changes based on at least one of the context data and time.

16. The communication device of claim 11, wherein the context data comprises at least one of HTML (hypertext markup language) data, HTML tags, text data and image data.

17. The communication device of claim 11, wherein to determine the context data, the processor is further enabled to at least one of:
retrieve at least a first portion of the context data from the calendar database based on a current time;
request at least a second portion of the context data from a content server based on at least one of the first portion of the context data and the current time
receive the at least a second portion of the context data from the content server; and
process an API (application programming interface).

18. The communication device of claim 11, wherein to determine the context data, the processor processes an API (application programming interface) that interfaces with at least one of the calendar database and a remote content server.

19. The communication device of claim 11, wherein the processor is further enabled to store the context data in a resource file associated with the application, such that the context data can be retrieved from the resource file when the application is executed.

20. The communication device of claim 1, wherein the processor is further enabled to request content data from a content server based on at least one of at least a portion of the context data and a current time, and wherein to update the portion of the rendered icon data the processor is further enabled to update the portion of the rendered icon data using at least a subset of the content data.

21. A computer program product, comprising a non-transitory computer usable medium having a computer readable program code adapted to be executed to implement a method for processing context data at a communication device, the communication device comprising a processor interconnected with a memory, a display device and a communication interface, the method comprising:
rendering icon data associated with an application at the display device, thereby providing rendered icon data at the display device, the icon data and the application stored at the memory;
determining context data associated with the application by retrieving at least a first portion of the context data from a calendar database, the context data for rendering within the application when the application is executed by the processor and rendered at the display device;
updating a portion of the rendered icon data such that the rendered icon data comprises at least a subset of the context data; and
when the rendered icon data is actuated, responsively executing the application at the processor such that the context data is rendered at the display device within a rendering of the application.
